(19) United States
(12) Patent Application Publication
(10) Pub. No.: US 2016/0278194 A1
(43) Pub. Date: Sep. 22, 2016

(54) SOFT X-RAY ANTI-STATIC APPARATUS FOR VACUUM CHAMBER

(71) Applicant: SUNJE HI-TEK CO., LTD., Gijang-gun, Busan (KR)

(72) Inventors: Dong Hoon LEE, Haeundae-gu, Busan (KR); Yong Chul JUNG, Suyeong-gu, Busan (KR); Sang Hyo KIM, Suyeong-gu, Busan (KR); Su Young LEE, Busanjin-gu, Busan (KR)

(21) Appl. No.: 15/028,254

(22) PCT Filed: Oct. 14, 2014
(86) PCT No.: PCT/KR2014/009601

§ 371 Date: Apr. 8, 2016

(30) Foreign Application Priority Data
Oct. 15, 2013 (KR) 10-2013-0122604

(51) Int. Cl. H05G 1/26

(52) U.S. Cl. CPC H05G 1/26

(57) ABSTRACT

The present invention provides a soft X-ray anti-static apparatus for a vacuum chamber, including: a high voltage generation unit for generating a high voltage for generating a soft X-ray; a soft X-ray generation unit for generating the soft X-ray by using the high voltage, and outputting the generated soft X-ray to the outside; a flexible connection unit for connecting the high voltage generation unit with the soft X-ray generation unit and transmitting the high voltage to the soft X-ray generation unit; and a fastening unit provided on the soft X-ray generation unit so as to be fastened to a predetermined target object.

### CROSS-REFERENCE TO RELATED APPLICATION

This application claims priority from Korean Patent Application No. 10-2013-0122604, filed on Oct. 15, 2013, in Korean Intellectual Property Office, the contents of which are hereby incorporated by reference in their entirety for all purposes.

### BACKGROUND OF THE INVENTION

1. Field of the Invention

The present invention relates generally to a soft X-ray anti-static apparatus for a vacuum chamber to efficiently remove static electricity generated in the vacuum chamber during a process.

2. Description of Related Art

Generally, large scale integrated circuits such as memory devices, planar-type devices such as TFTs, or ICs are manufactured through a variety of reaction chambers (or process chambers) through which predetermined manufacturing processes are carried out.

The reaction chambers for manufacturing such semiconductor devices are generally maintained in a vacuum state. For example, when a target wafer is loaded, a reaction chamber formed with a quartz boat for carrying out a dry etching process is vacuumized.

During sequential manufacturing processes, large scale integrated circuits such as memory devices, planar-type devices such as TFTs, or ICs are sequentially transferred to respective corresponding reaction chambers by using transfer chambers arranged between reaction chambers for manufacturing processes. However, a great amount of static electricity exists in the transfer chambers.

In particular, when products or semi-products produced via respective reaction chambers are conveyed from respective reaction chambers to the transfer chamber, products or semi-products are subjected to a great quantity of static electricity accumulated in the transfer chamber.

Thus, unless static electricity accumulated in the transfer chamber is appropriately removed, quality of products or semi-products may be negatively affected during conveyance.

That is, in the case of flat-display products, for example, if static electricity accumulated in reaction chambers is not appropriately removed, the static electricity may cause problems of various operation errors, such as touch-perception errors, abnormal screen driving, linear defects, screen flickering, or glass breakage.

### SUMMARY OF THE INVENTION

### Technical Problem

Accordingly, the present invention has been made keeping in mind the above problems occurring in the related art, and an object of the present invention is to provide a soft X-ray anti-static apparatus capable of irradiating a soft X-ray toward the inside of a vacuum chamber to remove static electricity.

Another object of the present invention is to provide a soft X-ray anti-static apparatus capable of detachably attaching a soft X-ray generator to a vacuum chamber to irradiate a soft X-ray.

A still another object of the present invention is to provide a soft X-ray anti-static apparatus capable of variably controlling locations of a soft X-ray to be generated, without direct attachment to the inside of a vacuum chamber.

### Technical Solution

In order to accomplish the above objects, the present invention provides a soft X-ray anti-static apparatus for a vacuum chamber, including: a high voltage generation unit generating a high voltage for generating a soft X-ray; a soft X-ray generation unit generating the soft X-ray by using the high voltage, and outputting the generated soft X-ray to the outside; a flexible connection unit connecting the high voltage generation unit with the soft X-ray generation unit and transmitting the high voltage to the soft X-ray generation unit; and a fastening unit provided onto the soft X-ray generation unit so as to be fastened to a predetermined target object.

The target object may be a vacuum chamber capable of forming a vacuum state.

The soft X-ray generation unit may penetrate through the vacuum chamber so as to be exposed to an internal space thereof, and the fastening unit may fasten the soft X-ray generation unit onto an outer wall part of the vacuum chamber.

The fastening unit may include: a fastening member provided around the soft X-ray generation unit, a coupling means having a plurality of coupling holes provided onto the fastening member so as to be spaced apart at specified intervals, and a plurality of coupling members fastened to an outer wall part of the vacuum chamber through the coupling holes.

A silicone gasket may be further provided between the fastening member and the outer wall part of the vacuum chamber to assist the vacuum chamber in maintaining a vacuum state.

The soft X-ray generation unit may be provided with respect to the vacuum chamber such that an end portion thereof protrudes into the internal space of the vacuum chamber based on an inner wall part of the vacuum chamber.

The end portion of the soft X-ray generation unit may be disposed so as to be flush with the inner wall part of the vacuum chamber.

The vacuum chamber may be provided with a through-hole through which the soft X-ray generation unit is inserted and fitted.

The through-hole may be provided, on an inner circumference thereof, with a sealing member formed of silicone to be closely fitted around an outer circumference of the soft X-ray generation unit so as to maintain the vacuum state of the vacuum chamber.

The soft X-ray generation unit may have a cylindrical shape and is coupled to the through-hole in a screw-coupled manner.

The soft X-ray generation unit and the through-hole may have at least one stepped part to assist close fitting therebetween.

The end portion of the soft X-ray generation unit may be horizontally rotated while being exposed to the internal space of the vacuum chamber.

The soft X-ray generation unit may further include a rotary unit to rotate the end portion of the soft X-ray generation unit to adjust a rotation position of the end portion in response to reception of an external control signal.

The soft X-ray anti-static apparatus may further include an anti-static control unit.

The anti-static control unit may include a measuring device to measure a level of static electricity in the internal space of the vacuum chamber, and a controller to control the drive of the high voltage generation unit to generate a predetermined amount of soft X-rays in response to the measured level of static electricity.

### Advantageous Effects

The present invention has an effect of providing a soft X-ray for anti-static in the vacuum chamber.

In addition, the present invention has an effect of detachably installing the soft X-ray generation unit for generating a soft X-ray onto the vacuum chamber.

Further, the present invention has an effect of variably controlling locations of a soft X-ray to be generated, without direct attachment to the inside of a vacuum chamber.

### BRIEF DESCRIPTION OF THE DRAWINGS

FIG. 1 is a perspective view illustrating a soft X-ray anti-static apparatus for a vacuum chamber according to an embodiment of the present invention;

FIG. 2 is a view illustrating a high voltage generation unit of the soft X-ray anti-static apparatus;

FIG. 3 is an exploded perspective view illustrating the high voltage generation unit;

FIG. 4 is a cross-sectional view illustrating the high voltage generation unit of FIG. 3;

FIG. 5 is a cross-section view illustrating an example of the soft X-ray anti-static apparatus being installed in a vacuum chamber;

FIG. 6 is a cross-sectional view illustrating an example of a body of a soft X-ray generation unit being fitted through a through-hole;

FIG. 7 is a view illustrating an example of an end portion of the soft X-ray generation unit being configured to be rotatable; and

FIG. 8 is a view illustrating the soft X-ray anti-static apparatus having an anti-static control unit.

### DETAILED DESCRIPTION OF THE PREFERRED EMBODIMENTS

An exemplary embodiment of a soft X-ray anti-static apparatus for a vacuum chamber will now be described with reference to the accompanying drawings.

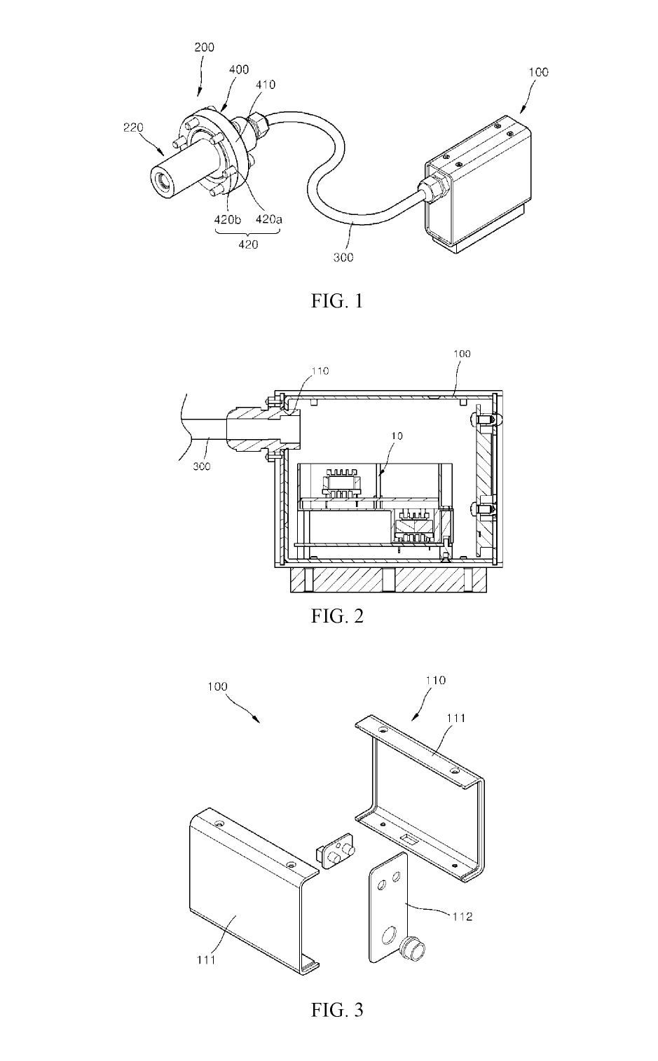

FIG. 1 is a perspective view illustrating a soft X-ray anti-static apparatus for a vacuum chamber according to an embodiment of the present invention, and FIG. 2 is a view illustrating a high voltage generation unit of the soft X-ray anti-static apparatus.

The soft X-ray anti-static apparatus 200 is detachably installed onto a vacuum chamber.

Referring to FIGS. 1 and 2, the soft X-ray anti-static apparatus includes a high voltage generation unit 100, a soft X-ray generation unit 200, a flexible connection unit 230, and a fastening unit 400.

The high voltage generation unit 100 serves to generate a high voltage for producing a soft X-ray.

Referring to FIG. 3, the high voltage generation unit 100 is provided with a casing 111 having a power source (not shown) therein.

Referring to FIG. 1, the flexible connection unit 300 has a tube body formed in a certain length from a flexible material. A silicone layer (not shown) may be further provided to the connection unit in order to prevent leakage of a soft X-ray to the outside.

One end of the flexible connection unit 300 may be coupled to a fitting part 113a by means of a nut. A sealing ring (not shown) may be further installed onto a coupled section.

The other end of the flexible connection unit 300 may be coupled to the soft X-ray generation unit 200. The connection unit 300 serves to transfer a high voltage generated from the high voltage generation unit 100 to the soft X-ray generation unit 220.

The soft X-ray generation unit 200 includes a body part 210, a soft X-ray tube part 220 installed in the body part 210 and through which a soft X-ray is irradiated to the outside, a silicone molding part 230 surrounding the soft X-ray tube part 220 to prevent leakage of a soft X-ray to the outside, and a head cap part 240 coupled to a distal end of the body part 210.

Here, the body part 210 may preferably have a cylindrical shape.

Referring to FIG. 4, the fastening unit 400 includes a fastening member 410 and a coupling means 420.

The fastening member 410 has a cylindrical body with a specified thickness, which is provided around the body part 210 of the soft X-ray generation unit.

Here, the fastening member 410 is coaxially provided around the body part 210 of the soft X-ray generation unit.

The fastening member 410 may preferably be integrated with the body part 210 of the soft X-ray generation unit.

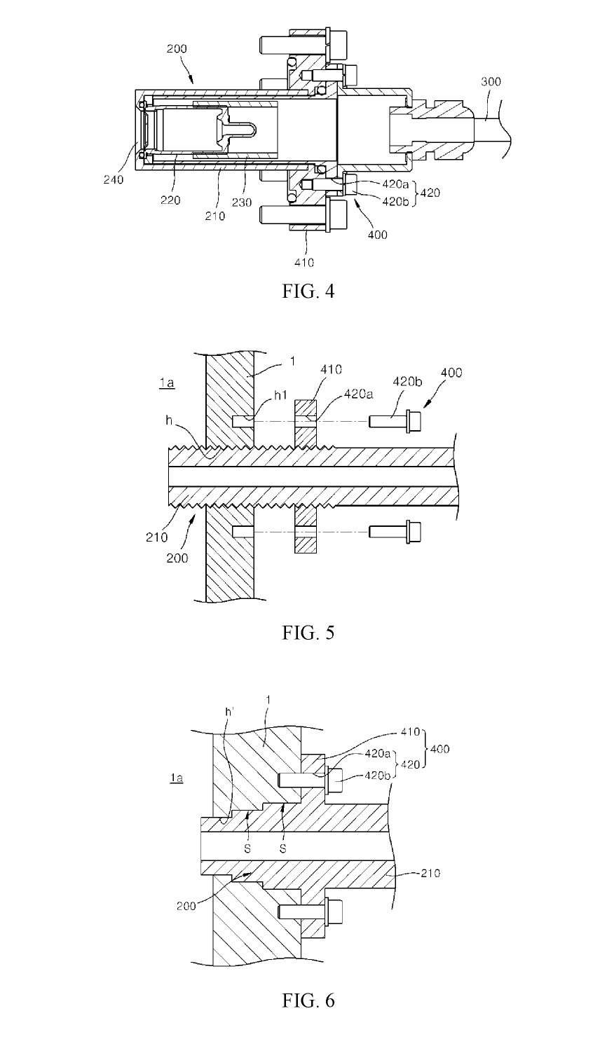

Alternatively, as illustrated in FIG. 5, the fastening member 410 may be installed onto the body part 210 such that the fastening member is forwardly and inversely rotated about the body part 210 so that the fastening member moves back and forth along the body part 210 in the longitudinal direction thereof.

In this case, the fastening member 410 may preferably be coupled onto an outer circumference of the body part 210 of the soft X-ray generation unit in a screw-coupling manner.

The coupling means 420 includes a plurality of coupling holes 420a provided on the fastening member 410 so as to be spaced apart at specified intervals, and a plurality of coupling members 420b coupled to an outer wall part of the vacuum chamber through the coupling holes 420a.

The coupling members 420b may be coupling bolts to be fitted through the coupling holes 420a in a screw-coupling manner.

The coupling members 420b may be screw-coupled through the outer wall part of the vacuum chamber along with coupling through the coupling holes 420a.

In the meantime, as illustrated in FIG. 5, the outer wall part of the vacuum chamber 1 is provided with a through-hole h into which the body part 210 of the soft X-ray generation unit is fitted.

The through-hole h may have a solid inner circumference or a threaded inner circumference to be screw-coupled with an outer circumference of the body part 210 of the soft X-ray generation unit.

Here, an end portion of the body part 210 fitted into the through-hole h may be positioned so as to be substantially flush with an inner wall part of the vacuum chamber 1.

In this case, although not illustrated in the drawings, a cap (not shown) may be further installed around the through-hole h on the side of the inner wall part of the vacuum chamber 1.

Here, one side of the fastening member 410 provided around the body part 210 of the soft X-ray generation unit is arranged so as to come into contact with the outer wall part of the vacuum chamber 1.

The coupling holes 420a formed on the fastening member 410 and fastening holes hl formed on the outer wall part of the vacuum chamber 1 are provided at corresponding positions.

The plurality of coupling members 420b are fitted through the coupling holes 420a and the fastening holes hl.

Thus, the body part 210 of the soft X-ray generation unit may be fixed while being fitted through the through-hole h of the outer wall part of the vacuum chamber 1.

In addition, a silicone gasket (not shown) may be further installed between the outer wall part of the vacuum chamber 1 and one side of the fastening member 410.

The silicone gasket serves to protect the soft X-ray tube part 220 in front of the silicone gasket and to fix or protect a connection part of the X-ray tube part 220.

Here, as illustrated in FIG. 5, when the body part 210 is screw-coupled through the through-hole h, a sealing member (not shown) formed of a silicone material may preferably be provided on the inner circumference of the through-hole h as a coat.

Referring to FIG. 5, the end portion of the body part 210 of the soft X-ray generation unit may be fixedly installed so as to protrude into an internal space 1a of the vacuum chamber 1.

This can be realized in a case where the fastening member 410 is variably fastened onto the body part 210 along the longitudinal direction as described before.

In this case, the end portion of the body part 210 of the soft X-ray generation unit moves back and forth relative to the internal space 1a of the vacuum chamber 1, so that the irradiating location of a soft X-ray can be controlled.

In this case, the fastening member 410 is screw-coupled with the body part 221 of the soft X-ray generation unit.

FIG. 6 is a cross-sectional view illustrating an example of the body part of the soft X-ray generation unit being fitted through the through-hole.

Referring to FIG. 6, the soft X-ray generation unit 200 and the through-hole h′ may have at least one stepped part S.

The stepped part S serves to prevent a motion of the body part 210 at a fastened position and also to more effectively prevent leakage of a vacuum since the stepped part S forms multiple layers.

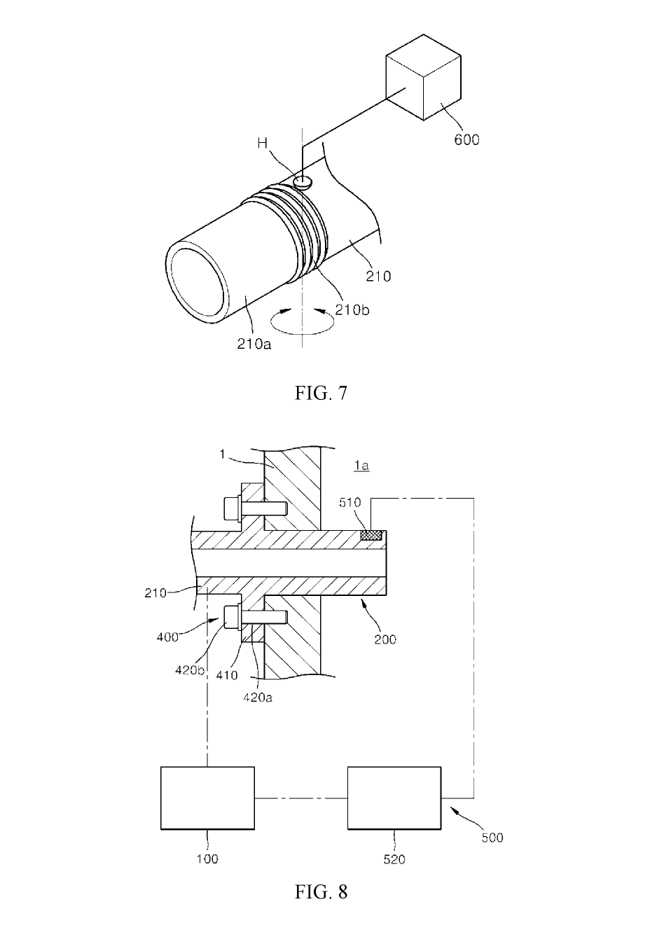

FIG. 7 is a view illustrating an example of the end portion of the soft X-ray generation unit being configured to be rotatable.

Referring to FIG. 7, the end portion of the body part 210 may be formed as a rotatable body 221a that is horizontally rotatable in a state of being exposed to the internal space 1a of the vacuum chamber 1.

Thus, a flexible outer tube 210b may be installed between the body part 210 of the soft X-ray generation unit and the rotatable body 210a.

The flexible outer tube 210b is provided with a rotation end section H to cause the rotatable body 210a to be rotated. The rotation end section H is connected to a rotary device 600.

The rotary device 600 may rotate the rotatable body 210a so that a position of the end portion of the soft X-ray generation unit 200 is rotated, in response to reception of an external control signal.

Since a direction in which the end portion of the body part of the soft X-ray generation unit, from which a soft X-ray is output, faces is regulated through control action of the rotary device, the end portion may be regulated so as to direct towards a wide side of the vacuum chamber by taking account of a spatial area of the internal space of the vacuum chamber.

FIG. 8 is a view illustrating the soft X-ray anti-static apparatus having an anti-static control unit.

Referring to FIG. 8, the soft X-ray anti-static apparatus further includes the anti-static control unit 500.

The anti-static control unit 500 includes a measuring device 510 to measure a level of static electricity in the internal space 1a of the vacuum chamber 1, and a controller 520 to control the drive of the high voltage generation unit 510 to generate a predetermined amount of soft X-rays in response to the measured level of static electricity.

The measuring device 510 may be installed on the side of the inner wall part of the vacuum chamber 1, or otherwise may be installed so as to protrude from the end portion of the body part 210 of the soft X-ray generation unit.

The measuring device 510 measures a level of static electricity in the internal space 1a of the vacuum chamber 1 and transmits a measured value to the controller 520.

The controller 520 is set to generate a predetermined amount of static electricity in response to the level of static electricity.

Thus, the controller 520 can control the drive of the high voltage generation unit 100 to generate a predetermined amount of soft X-rays in response to the measured level of static electricity.

According to the configuration and the operation described in the foregoing description, the embodiment of the present invention can provide a soft X-ray for anti-static in the vacuum chamber.

In addition, the embodiment of the present invention is configured to realize detachable installation of the soft X-ray generation unit for generating a soft X-ray onto the vacuum chamber.

Further, the present invention can variably control locations of a soft X-ray to be generated, without direct attachment to the inside of a vacuum chamber.

Furthermore, the embodiment of the present invention can efficiently remove static electricity in an internal space of a vacuum chamber, thereby solving problems of flat panel displays manufactured in a vacuum chamber, such glass breakage or various operation errors including touch-perception errors, abnormal screen driving, linear defects, and screen flickering.

Although exemplary embodiments of manufacturing equipment for flat panel displays, including a soft X-ray anti-static apparatus, have been described, it is apparent that various modification can be made to the disclosed embodiments without departing from the scope of the invention.

Thus, the scope of the present invention should not be limited to the disclosed embodiments, and should be defined by features of following claims and equivalent features thereof.

That is, it should be construed that the disclosed embodiments are merely exemplary examples in all aspects and the scope of the invention is defined by following claims, rather than the detailed description, and all of changes and modifications derived from the meaning, scope, and equivalent concepts of the claims are included in the scope of the invention.

Industrial Applicability: The present invention is applicable to means for removing static electricity generated in a vacuum chamber.

What is claimed is:

1. A soft X-ray anti-static apparatus for a vacuum chamber, the apparatus comprising:
a high voltage generation unit generating a high voltage for generating a soft X-ray;
a soft X-ray generation unit generating the soft X-ray by using the high voltage, and outputting the generated soft X-ray to the outside;
a flexible connection unit connecting the high voltage generation unit with the soft X-ray generation unit and transmitting the high voltage to the soft X-ray generation unit; and
a fastening unit provided onto the soft X-ray generation unit so as to be fastened to a predetermined target object.

2. The soft X-ray anti-static apparatus of claim 1, wherein the target object is a vacuum chamber capable of forming a vacuum state, wherein the soft X-ray generation unit penetrates through the vacuum chamber so as to be exposed to an internal space thereof, and wherein the fastening unit fastens the soft X-ray generation unit onto an outer wall part of the vacuum chamber.

3. The soft X-ray anti-static apparatus of claim 2, wherein the fastening unit comprises:
a fastening member provided around the soft X-ray generation unit,
a coupling means having a plurality of coupling holes provided on the fastening member so as to be spaced apart at specified intervals, and
a plurality of coupling members fastened to an outer wall part of the vacuum chamber through the coupling holes.

4. The soft X-ray anti-static apparatus of claim 3, wherein a silicone gasket is further provided between the fastening member and the outer wall part of the vacuum chamber to assist the vacuum chamber in maintaining a vacuum state.

5. The soft X-ray anti-static apparatus of claim 3, wherein the soft X-ray generation unit is provided with respect to the vacuum chamber such that an end portion thereof protrudes into the internal space of the vacuum chamber based on an inner wall part of the vacuum chamber.

6. The soft X-ray anti-static apparatus of claim 3, wherein the end portion of the soft X-ray generation unit is disposed so as to be flush with the inner wall part of the vacuum chamber.

7. The soft X-ray anti-static apparatus of claim 3, wherein the vacuum chamber is provided with a through-hole through which the soft X-ray generation unit is inserted and fitted, and wherein the through-hole is provided, on an inner circumference thereof, with a sealing member formed of silicone to be closely fitted around an outer circumference of the soft X-ray generation unit so as to maintain the vacuum state of the vacuum chamber.

8. The soft X-ray anti-static apparatus of claim 7, wherein the soft X-ray generation unit has a cylindrical shape and is coupled to the through-hole in a screw-coupled manner.

9. The soft X-ray anti-static apparatus of claim 7, wherein the soft X-ray generation unit and the through-hole have at least one stepped part to assist close fitting therebetween.

10. The soft X-ray anti-static apparatus of claim 2, wherein the end portion of the soft X-ray generation unit is horizontally rotated while being exposed to the internal space of the vacuum chamber, and wherein the soft X-ray generation unit further includes a rotary unit to rotate the end portion of the soft X-ray generation unit to adjust a rotation position of the end portion in response to reception of an external control signal.

11. The soft X-ray anti-static apparatus of claim 2, wherein the soft X-ray anti-static apparatus further comprises an anti-static control unit, wherein the anti-static control unit includes a measuring device to measure a level of static electricity in the internal space of the vacuum chamber, and a controller to control the drive of the high voltage generation unit to generate a predetermined amount of soft X-rays in response to the measured level of static electricity.
